(19) United States
(12) Patent Application Publication
(10) Pub. No.: US 2002/0184102 A1
(43) Pub. Date: Dec. 5, 2002

(54) Selling price information in e-commerce

(76) Inventors: Panagiotis Markopoulos, Philadelphia, PA (US); Lyle Ungar, Philadelphia, PA (US)

Correspondence Address: DILWORTH PAXSON LLP, 3200 MELLON BANK CENTER, 1735 MARKET STREET, PHILADELPHIA, PA, 19103, US

(21) Appl. No.: 09/813,389

(22) Filed: Mar. 21, 2001

(51) Int. Cl. G06F 17/60

(52) U.S. Cl. 705/26

(57) ABSTRACT

The present invention sets forth a model, method, database and system by which it is possible for sellers to provide product information to consumers through shopbots, while at the same time charging for price information. In a preferred embodiment of the invention there is provided a model for responding to a shopper's inquiry seeking price information on a product in a competitive marketplace, comprising: receiving the shopper's inquiry for price information on a product; searching for price information of advertised products matching the product for which the price is sought; assembling identified price information into a response to the inquiry, wherein the price of at least one product is withheld from the response; forwarding the assembled response to the shopper along with a cost for obtaining the previously withheld price information; receiving the shopper's agreement to buy the previously withheld price information; and forwarding to the shopper the previously withheld price information in exchange for the agreed upon payment of the cost for the price information. The search for the price information comprises a search of at least one database, which may include an electronic search on a global computer network. Moreover, the price information may be provided to the seller by a variety of known ways, including via a shopbot or directly via a seller of the product.

### GOVERNMENT SUPPORT

This work was supported in part by grants from the National Science Foundation Grant SBR 96-02053. The government may have certain rights in this invention.

### FIELD OF THE INVENTION

The present invention provides a business method in the field of e-commerce, regarding pricing information available to buyers and sellers of goods and services over a global computer network, the Internet.

### BACKGROUND OF THE INVENTION

Shopbots are programs that automatically search the Internet for information that pertains to the price and quality of advertised goods or services on behalf of consumers (Chavez & Maes, In Proceedings of the First International Conference on the Practical Application of Intelligent Agents and Multi-Agent Technology, (1996); Eriksson et al., In Proceedings of the Second USENIX Workshop on Electronic Commerce (1996); Kephart et al., in Proceedings of the Sixth International Conference on Artificial Life, Cambridge, Mass., The MIT Press (1998); Kephart et al., in Proceedings of the Second International Workshop on Cooperative Information Agents (1998); Kephart & Greenwald in Autonomous Agents and Multi-Agent Systems (2000); Kephart & Greenwald, A., Autonomous Agents '99 (1999); and Tsvetovatyy et al., Applied Artificial Intelligence (1997)). In response to a consumer's expressed interest in a specified good or service, a typical shopbot can query several dozen web sites, and within seconds collate and sort the available information for the user. For example, “shopper.com” claims to compare 1,000,000 prices on 100,000 computer-oriented products.

Shopbots deliver on one of the great promises of electronic commerce and the Internet—a radical reduction in the cost of obtaining and distributing information. The product coverage provided by a shopbot in just a few seconds, far exceeds the capability of a patient, determined human shopper laboring through many hours of manual search. Consequently, since the launch of BargainFinder, a CD shopbot, in June 1995, scores of shopbots have emerged. One of the more popular shopbots, “mysimon.com,” provides information about office supplies, groceries, toys, apparel, and consumer electronics, just to name a few of the items on its product line. In addition, “acses.com” compares the prices of books offered for sale on-line, while “jango.com” and “webmarket.junglee.com” offer everything from apparel to gourmet groceries. Another shopbot, “DealPilot.com,” gathers, collates, and sorts the prices and expected delivery times of books, CDs, and movies offered for sale on-line.

The study of the economics of information was launched in the seminal work of Stigler, Journal of Political Economy, 69(3):213-225 (1961). Stigler cites several examples of observed price dispersion, which he attributes to the costly search procedures that consumers face. Consequently, he notes the utility of trade journals and organizations that specialize in the collection and dissemination of product information, such as Consumer Reports, participate in localized markets rather than search for buyers individually.

Arguably, one of the first strategic-pricing economic agents with similarities to modem shopbots started operation in 1975, when US Congress declared the creation of a national market system, responsible for the joint dissemination of stock price data from US stock exchanges. The system permitted brokers to compare stock price data across the participating stock exchanges before placing an order, thereby assuring that they were trading at the best price. This data dissemination arrangement, under the Consolidated Tape Association (“CTA”) and Consolidated Quotation (“CQ”) Plans, produced a source of price information with many similarities to modem shopbots. Securities were perceived to be undifferentiated products by investors who equally trusted the participating stock exchanges. Consequently, the study of the CTA and CQ plans provides valuable intuition about the future of today's nascent Internet markets.

In the original stock exchange system, data made available by the markets that trade New York Stock Exchange (NYSE)-listed securities (“Network A”) were gathered, and then sold to individuals or organizations at a price to which Network A boards had to agree, and SEC had to approve. The profits were then distributed among the Network A members according to their costs of providing the data. Technology considerations at the time made any other arrangement (e.g., markets selling the data individually) impractical. Arguably, the most useful piece of information included in the data was information regarding the price of the securities. Network A has been selling price information for a quarter of a century with a price based on cost, as opposed to one based upon the marginal buyer utility.

Recently the New York Stock Exchange Board of Directors announced NYSE's withdrawal from the CTA and CQ Plans, with the intention of catalyzing a pro-competitive solution that will take advantage of today's technology (NYSE Press Release dated Apr. 10, 2000 in reply to a Securities and Exchange Commission's release, titled “Market Data Concept Release” (Buck, 2000)). NYSE's proposal was to allow individual markets to compete on selling market data to the public. Obviously, the price information for securities traded in NYSE is more valuable than any other market, because (due to higher volume) brokers are more likely to find a best price. NYSE expects a substantial revenue increase if it is allowed to sell price (and other) data to the public at competitively determined prices, naturally connected to the public marginal utility for the data.

Interestingly, it appears that the only alternative solution considered by the NYSE was for Network A markets to sell their data according to the “Ramsey Pricing” scheme, proposed by Frank Ramsey (Economic Journal 37 (1927)). Ramsey prices depend upon both a firm's marginal costs, and the elasticities of demand for the services the firm sells. Demand for NYSE's price data would, of course, be quite inelastic.

Although the pricing factors involved in the NYSE are highly complex, what is shown is that price information can have significant value. Companies, such as the NYSE want to charge the real value of their price information. Furthermore, the historical stock price dissemination scheme, which covers the market's charges for price information by a fixed revenue that is almost exogenous to the market, does not reflect the economic value of the price information.

Many economists have developed and analyzed formal models that attempt to explain the phenomenon of price dispersion. In the absence of shopbots and strategic search costs, a model of sellers' price adjustment was studied by Diamond (Economic Theory 3:156-168 (1971)), in which a somewhat paradoxical outcome arises: for any positive search costs, no consumers search and all sellers charge the monopolistic price. Bakos (Management Science 43(12) (1997)) discusses the potential impact of reduced buyer search costs on the electronic marketplace. However, while the Bakos model allows for product differentiation, it does not allow for varying types among buyers.

Others, such as Salop and Stiglitz (Review of Economic Studies 44:493-510 (1977)) have studied the question of how sellers could make any profit at all in a competitive commodities market, because the traditional Bertrand equilibrium argument suggests that competitive pressures should drive prices down to the marginal production cost. They found that the costliness of discovering prices—a factor not taken into account in the traditional Bertrand argument—could make it rational for buyers to forego comparing prices. This in turn allows sellers to charge more than the marginal production cost. Potential sources of price dispersion in the electronic age, include for example, product heterogeneity, convenience, awareness, brand, lock-in and price discrimination.

Today, shopbots serve as local marketplaces in the global information superhighway. Logically, the rapid flow of information will profoundly affect market efficiency, and the reduced economic friction will lead to increased competition among sellers, when compared with conventional markets of bricks and mortar retailers (Green, Business Week, 71-84 (May 4 1998); Lewis, The Friction-Free Economy: Marketing Strategies for a Wired World, (1997); DeLong & Froomkin, in Internet Publishing and Beyond: The Economics of Digital Information and Intellecutal Property (1998)). This is because the typical buyer would prefer to purchase goods and services from the lowest-priced, highest-quality dealer, if he can efficiently obtain complete and accurate information at a very low cost. As a result, in today's electronic marketplace, many vendors view shopbots as a means of attracting consumers who otherwise might not have known about them, or might not have thought to purchase from them (DeLong & Froomkin, 1998). Some vendors even sponsor shopbots, by paying for the opportunity for their products to be listed on shopping sites such as “shopper.com.”

In their qualitative investigation into the ongoing emergence of shopbots, DeLong and Froomkin, supra, point out that, short of violating anti-trust laws, sellers will be hard pressed to prevent their competitors from sponsoring shopbots, and that the sellers who do not do so, will experience decreased sales. Looking ahead, therefore, it seems inevitable that shopbots will evolve into economic entities in their own right, interacting with billions of other economically-motivated software agents.

However, the new Internet economy is far from frictionless, and considerable and persistent price dispersion exists (Brynjolfsson & Smith, Management Science (2000)). This price dispersion is large enough to make price information valuable to consumers who are price sensitive and want to compare prices before buying a good or service. A question that naturally arises for e-tailers (electronic retailers) is: If this information is so valuable, then why is it provided at no cost? In fact, the sellers' incentives to start charging for price information cannot be overlooked. If shopbots, that provide free services and profit only through advertising, do not want to pass this cost to consumers, they will have to share their advertising revenues with demanding sellers. This will become an issue, particularly in markets in which high price dispersion might lead to the collapse of the free shopbot model or, more accurately, the constant cost model for these markets. In fact, the impact of agent technology on the nascent information economy remains unknown.

In a preliminary draft of an article entitled, “Dynamic Pricing by Software Agents,” Computer Networks, Elsevier Publishers (in press), Kephart and Hanson calculate how much a shopbot could charge for price information, given that it can manipulate the buyer's cost structure. The shopbot extracts all surplus from the market. However, the analysis offers no information to show that a shopbot can sell price information, even though other shopbots provide it for free. In fact, it would seem to indicate that it cannot, since logically all buyers would prefer the free information.

It is increasingly clear, however, that there is a need in the art for sellers to have the advantages provided by shopbot sites, e.g., free product advertisement and brand awareness, while profiting from the price information provided to the consumer. Specifically, a method or system must be devised through which shopbots can adequately price their services to maintain profitability, while at the same time continuing to provide consumers with incentives to subscribe.

### SUMMARY OF THE INVENTION

The present invention provides, for the first time, a correlation between product prices and the information value generated by the price of the product to the retailer or e-tailer. These findings not only prove that the issue is important in e-commerce, but it provides data that will influence the structure of future Internet markets. The present invention sets forth a model, method, database and system by which it is possible for sellers to provide free product information to consumers through shopbots, while at the same time charging for price information.

The fundamental difference between the method provided by the present invention over that of the prior art is that in the preferred embodiment the buyers can be charged by sellers for price information, when they choose to compare prices with the help of a shopbot. This is primarily because a seller can manipulate his own product price, and subsequently the information value that it generates, but a shopbot cannot. In fact, the invention has proven to be profitable, while withstanding competition. Moreover, it is not limited to a particular pricing scheme. Not only can the pricing scheme exemplified in the present invention be used to effectively set the price for price information, but the disclosed methods are effective when applied to the pricing scheme of Kephart and Hanson (in press, supra), as well as to other pricing schemes. In fact, the Kephart and Hanson pricing scheme can be used in the method of the invention to help sellers set the prices they charge for price information.

In a preferred embodiment of the invention there is provided a method for responding to a shopper's inquiry seeking price information on a product in a competitive marketplace, comprising: receiving the shopper's inquiry for price information on a product; searching for price information of advertised products matching the product for which the price is sought; assembling identified price information into a response to the inquiry, wherein the price of at least one product is withheld from the response; forwarding the assembled response to the shopper along with a cost for obtaining the previously withheld price information; receiving the shopper's agreement to buy the previously withheld price information; and forwarding to the shopper the previously withheld price information in exchange for the agreed upon payment of the cost for the price information.

The search for the price information comprises a search of at least one database, which may include an electronic search on a global computer network. The price information may be provided to the seller by a variety of known ways, including via a shopbot or directly via a seller of the product. However, the product price information is ultimately purchased from a seller of the product. A shopbot may also purchase the price information from the seller.

It is further provided that the shopper expresses agreement to pay the cost for obtaining the previously withheld price information by methods recognized by an electronic device, selected from the group consisting of clicking or pressing a button on a computer or communications device, following a link displyed on a web page on a global computer network, touching a designated point on a screen or display panel attached to a computer or communications device, and speaking a selection into an audio receiver attached to a computer or communications device.

In a preferred embodiment of the invention there is also provided a database on a computer readable medium for facilitating a response to a shopper's inquiry seeking price information on a product in a competitive marketplace, wherein the price information is provided to the shopper for a fee, comprising a number of data objects, and whereby any of the data objects are instantiated in order to populate the database. The objects comprise information such as, but not limited to, a field for entering an inquiry asking for price information of a product; a field for searching for price information of advertised products; a field for assembling product price information into a response, wherein the price of at least one product is withheld from the response, and wherein a cost is provided whereby the withheld price will be provided; a field for receiving an agreement to buy the previously withheld price information, and; a field for forwarding the previously withheld price information in exchange for the agreed upon payment of the cost for the price information. One or more objects may also provide data source(s) for additional objects.

In addition, in a preferred embodiment of the invention there is provided a system for accessing a database for facilitating a response to a shopper's inquiry seeking price information on a product in a competitive marketplace, wherein the price information is provided to the shopper for a fee, comprising a number of objects, whereby the system for accessing the database comprises means for viewing any or all of said objects. The system provides means for receiving the shopper's inquiry for price information on a product; means for searching for price information of advertised products matching the product for which the price is sought; means for assembling identified price information into a response to the inquiry, wherein the price of at least one product is withheld from the response; means for forwarding the assembled response to the shopper along with a cost for obtaining the previously withheld price information; means for receiving the shopper's agreement to buy the previously withheld price information; and means for forwarding to the shopper the previously withheld price information in exchange for the agreed upon payment of the cost for the price information. The system may comprise a network based apparatus, or it may, at least in part, comprise a first apparatus in a client-server relationship with a second apparatus.

Additional objects, advantages and novel features of the invention will be set forth in part in the description, examples and figures which follow, and in part will become apparent to those skilled in the art on examination of the following, or may be learned by practice of the invention.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings, certain embodiment(s) which are presently preferred. It should be understood, however, that the invention is not limited to the precise arrangements and instrumentalities shown.

FIG. 1 is a flowchart depicting the overall architecture of the preferred embodiment.

FIG. 2 depicts a hypothetical example of a seller charging for price information through a shopbot.

FIG. 3 depicts shopbot coverage, wherein shopbot 1 covers all sellers except j, while shopbot 2 covers all sellers, but charges a fee to reveal j's price.

### DETAILED DESCRIPTION OF THE INVENTION

The present invention provides a method by which sellers can benefit from the advantages provided by shopbot sites, in terms of product information, advertisement and brand awareness, while profiting from the price information provided to the buyer. Knowledge of the seller's competitive price information has value, for which the consumer will pay, so long as the cost of learning the price remains less than the cost of obtaining it.

For example, suppose that a buyer wanted to purchase the book, Harry Potter and the Sorcerer's Stone (list price $16.95). If the buyer were to drive to two or three local bookstores, it could take at least an hour or two to find and purchase the cheapest available copy of the book, and the savings would almost certainly not justify the time and expense of shopping. The shopping time could be reduced to perhaps fifteen minutes by contacting the same bookstores by telephone, or even to only five minutes by checking the Internet at “amazon.com,” “bn.com” (the online outlet for Barnes & Noble), and “borders.com.” In fact, one would currently find that each is offering the book for the same cost of $11.99.

However, if the same buyer were to use a shopbot for book at, for example, DealPilot.com, and specify Harry Potter and the Sorcerer's Stone, within twenty seconds a table of roughly fifty combinations of booksellers and shipping options would appear, presented in order from least to most expensive. At the top of the list, is “half.com” offering the used book for just $7.50—a savings of $9.45 (equal to a savings of 56% over the list price of the book), while “elgrande.com” offers the same new book for $10.23 (equal to a savings of 40% over list), which is still a savings of $1.76 (15%) over the bn.com price—all for less than one minute's work. A savings of time and cost, which many consumers would consider to be worthwhile.

It is inevitable that humans will not be able to keep up with the demands of responsive pricing on the millions of goods and services available electronically. As an increasing number of buyers begin to avail themselves of shopbots, and as shopbots become more pervasive and powerful, one of the frictional forces that has sustained profits for sellers in commodities markets will be reduced substantially. Price-aware buyers will become price-sensitive buyers, and they will force sellers to become extremely responsive in their pricing.

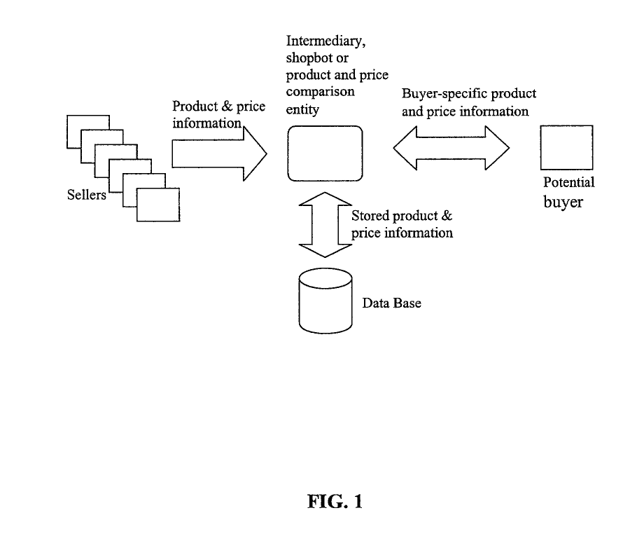

The methods and system of the present invention are defined by a model of a commodity market, wherein people shop through shopbot sites to derive the optimal pricing scheme for price information. To better understand this concept, the scenario is exemplified in FIG. 1, in which more that one seller starts selling price information and find that the seller offering the lowest product-price might eventually lowering his total revenues (product sales plus price information sales revenues), unless he sets his price by also taking the second lowest price in account.

In general, the process by which the potential buyer receives product price information contains the following steps:

1. The buyer specifies the product he/she is interested in.

2. The shopbot searches for the specified product.

3. The shopbot answers with information concerning the existence and/or specific product information, but withholds the price of one or more products that match the buyer-specified criteria.

4. The buyer specifies that he/she is willing to buy price information on one or more products for which the price or prices have not been revealed.

5. The shopbot provides the requested price information for a fee.

Of course, these steps are subject to modification according to specific situations without departing from the intent of the invention, as would be readily recognized by those skilled in the art. For example, Step 1 can be eliminated if the product or service the potential buyer requires is implied; Step 2 can either involve a request to the sellers for product and price information, or a search in the shopbot's database that contains product and price information; Step 2 can also include the shopbot's purchasing of product and price information from the seller; in Step 3, the shopbot can withhold product price information in a variety of ways. In each of these variations, there is a common theme, i.e., the buyer understands that he/she will need to request that information and accept the fees and terms associated with it. In Step 4, the buyer can specify the product price information he/she wants in a variety of ways, including but not limited to, clicking or pressing a button in a computer or communication device, following a link displayed on a web-page, touching a point on a screen or display, or orally dictating his/her selection. In Step 5, the fee is not limited to monetary payment, it can in the alternative be an indirect compensation, such as the buyer must watch a banner ad, or a commercial advertisement. ps 1.0 A Model of a Shopbot-Mediated Commodity Market

Far from following the Bertrand view of the markets, where prices are driven down to marginal cost, products sold on the Internet demonstrate a significant and persistent price dispersion. Such price dispersion results from a complex interaction in the marketplace of product heterogeneity, convenience, consumer awareness, brand, lock-in and price discrimination.

In the present invention, it is assumed for simplicity that price dispersion on the Internet exists due to the presence of multiple classes of consumers that value products in different ways and demonstrate distinct shopping behaviors. The sellers have optimized their capabilities by selecting a price for their products that maximizes their revenues across all classes of consumers. Further, it is assumed that among such consumers is a distinct class comprising shopbot users, who buy products based only on price.

However, in order to present a closed model to define this invention, some additional discussion and assumptions are needed. A first question arises as to why sellers would provide price information for a product for which they know they do not offer the lowest price. Even though, under the instant assumptions, sellers will never make a sale through a shopbot unless they offer their lowest price, such sellers are indifferent in providing this information. This is because, even if the seller denies it, he will not make a sale. Nevertheless, by displaying his pricing information on a shopbot site, the seller increases its brand recognition among consumers. Furthermore, a seller choosing to sell his price information might make additional revenues from the shopbot, even though the seller will not make a sale.

For example, if one were to consider a market comprising sellers that sell many, diverse, undifferentiated goods, such as books, CDs, electronics, etc, one class of sellers could represent bookstores that sell many different books, but each book is a commodity product across all sellers, uniquely identified by its ISBN. It is assumed that product prices follow a random distribution (f(x)), with the equivalent cumulative distribution denoted by (F(x)), constant across the time period relevant to a buyer's shopping session, which is exogenous to the present model. (Although this assumption is significant when deriving analytical results, it is not essential to prove that the disclosed business model is profitable. For example, a buyer can be convinced to buy price information, even if that buyer has no knowledge of the price distribution. In fact, even if this were a problem, the shopbot could simply provide the buyer with information regarding the price dispersion relating to the product that the buyer wants.)

A prospective buyer may know the distribution of the prices in the market, but he may not know which seller offers the cheapest price for the particular product in which he is interested. In the instant model, it is assumed that the buyer has no preference for a particular seller, and he is willing to buy from the seller offering the lowest price. For this reason, he will be willing to shop through a shopbot site that displays the prices of all sellers in the market for the products specified by the buyers.

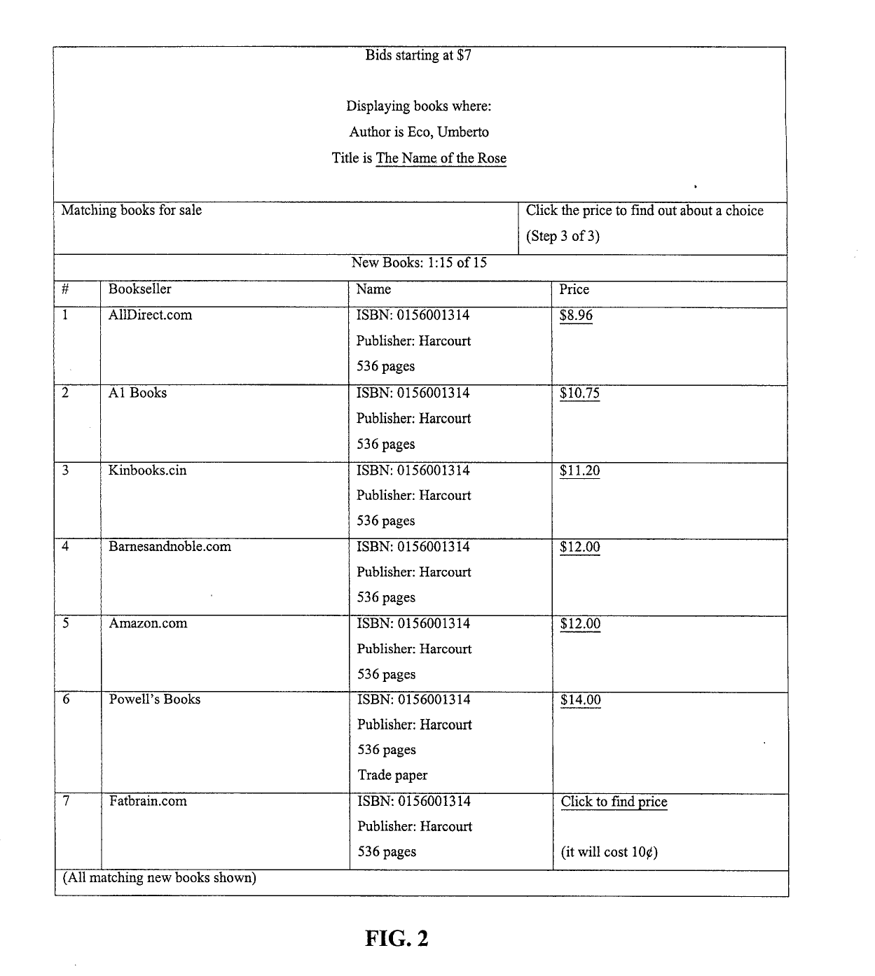

Accordingly, in the present model, seller (j) decides to sell his price information and contracts the shopbot to deliver all product information for free, except price, which will be available at an additional fee. The buyer will have to click on a button or a link and get j's price immediately by paying a price (p). Such a hypothetical agreement between Bookfinder.com and Fatbrain.com is shown in FIG. 2.

As shown in FIG. 2, when the shopbot Bookfinder.com was queried for a particular edition of Umberto Eco's Name of the Rose, 7 sellers could be found that offered the book. Next, the appearance of the page was changed to remove used books and other editions of the book and also to remove the Fatbrain.com price from the data.

There are three distinct entity classes in the relevant market: (i) the buyers, (ii) the sellers, and (iii) the shopbots. Each class faces a different problem, which is addressed in turn below.

1.1. The Buyer's Problem.

The buyer has three choices: (1) pay for the additional price, (2) do not pay, but simply accept the lowest price among the remaining (N−1) sellers without bothering to learn j's price, or (3) incur a fixed cost of inconvenience c, to visit the seller's website directly, which is assumed to be the same for all buyers. This inconvenience cost represents the time and effort to load a new web page, possibly learn a new user interface and repeat the query. Assuming that the buyer is rational, he will want to learn seller j's price, if he expects that the marginal cost saved by knowing the price is greater than the cost of acquiring it. Given that the minimum price for the good among the remaining N−1 sellers is q, the buyer knows that the expected decrease in the minimum price from another search is:

∫_{-∞}^{q}dF(x)f(x)dx=g(q) (Equation 1)

The integral starts from −∞ instead of zero to allow for negative prices. This is because only cost differences are relevant to the present invention, and de-meaned price dispersion data is used.

Thus, it is assumed that the buyer is willing to pay j's information price (p) to learn j's price if p<g(q) and p<c. Therefore, if p>g(q) and c>g(q), the buyer will be better off by purchasing the item priced at q without requesting any additional information. Finally, if c<g(q) and c<p, the reasonable buyer will visit j's website directly to learn j's price.

1.2 The Seller's Problem.

Seller j's problem is how to establish his price information to maximize his revenue. It is assumed that buyers have queried the shopbot site, and found that the current lowest price for the product they require is q, where q follows some distribution

$${f}_{min}^{N - 1} ( χ )$$

that depends on f(χ). This is simply the 1^{st} order statistic (see, Hogg & Craig, in Introduction to Mathematical Statistics, The Macmillan Company, New York, 2nd ed., 1965), shown to be

$${f}_{min}^{′} ( y ) = {( i ( 1 - F ( y ) ) )}^{i - 1} f ( y ) .$$

Of course, the seller j would know that he, too, can query the shopbot and obtain the free price quotes.

The seller can safely charge ∈ below g(q), given by Equation 1, knowing that a rational buyer will always want to know the seller's price. However, j cannot charge more than c, which is the inconvenience cost to the buyer of visiting j's website directly. As a result, the seller would set his price to be p(q)=min(g(q), c), where, again, q is the minimum price observed so far. This assumes that should the buyer decide to pay for seller j's price, the price will be displayed immediately upon request (shopbot prefetches the price, but withholds it), so there are no wait costs. The expected revenues per customer, for seller j from selling price information as ∈ goes to zero, are thus:

$$κ = {\int }_{- ∞}^{∞} {f}_{min}^{N - 1} ( q ) p ( q ) ⅆ q \qquad ( Equation 2 )$$

It is interesting to estimate how much an online bookstore would be able to charge for its price information to shopbots or shopbot users. Using internet book price dispersion data, including all costs (shipping, etc.), collected in Brynjolfsson & Smith, 2000, and assuming that all books follow the same price distribution, the de-meaned experimental data is fitted with the normal price distribution, with mean zero and a standard deviation of 2. For the shopper session set forth in FIG. 2, which is representative case of price dispersion, described well by the normal distribution with standard deviation 2, the shopper would expect to get a E(fₘᵢₙ⁶(q)) discount from the average market price of the book of $11.49, when the shopbot quotes six sellers. Thus, the expected value for fₘᵢₙ⁶ is −$2.53, which gives an expected minimum price of $8.96. The expected gain that a shopper would have from knowing one additional price is p(−$2.53), close to 9.8 cents. The value −$2.53 comes from the discount from the average price the buyer has gotten, by comparing prices among six booksellers. Thus, the seller could charge just under 9.8 cents less for this book's price information, to make sure that rational shoppers would pay his price.

A shopper could easily understand that it is worth paying for the additional price information. For example, a shopper looking at the website information depicted in FIG. 2, would immediately recognize that the lowest value can be $1.79 less than the second lowest price, even without requesting the extra price. If he expects to save $1.79 in one of every seven books, by acquiring one extra price quote, he would value this information at 25 cents. Of course, this is not the correct way that a rational shopper should value price information, but this example is used to show that the buyer can easily see the benefit of buying the extra price information in accordance with the present invention.

The average revenue the seller would expect from selling price information in this market with seven (7) sellers is, based upon Equation 2, approximately 15.6 cents per shopper. This assumes that the shopper would never pay more than 50 cents to learn a price and would rather visit the seller's website directly. The arbitrary 50 cent maximum is based on a “back of the envelope” calculation for what 2 minutes of time is worth to the average shopper, given today's US salaries.

For 20 sellers, the expected revenue per buyer, as calculated by Equation 2 is 4.3 cents. In this market the seller's average revenue per shopper is $11.74/20=$0.587. As a result, the 4.3 cents would be a 7.3% increase in revenues from sales made through shopbots. Thus, the business method of the invention, when employed in ‘balanced’ markets, where all sellers are equally likely to offer the best price, brings a considerable increase in the seller's revenues, even in markets where many sellers compete.

If seller j prices his price information with the method suggested above, a rational buyer will always request seller j's price information. As a result, seller j makes the revenues described by Equation 2 every time a consumer uses the shopbot. Consequently, the seller makes additional revenue for every product sold in the market through a shopbot. These revenues can be an important percentage of the revenue the seller makes by actual product sales. A simple calculation for the seven book sellers shown in FIG. 2 is as follows: assuming that each seller is equally likely to be the lowest price seller, he would expect to make 1/7 of the total shopbot book sales. For an average Internet book price of $11.74 (Brynjolfsson & Smith 2000), the average revenue per shopper is $11.74 /7=$1.68. Accordingly, the 15.6 cents would bring approximately a 9.3% increase in revenues from sales made through shopbots.

Accordingly, it seems that the sellers are the group with the real market power. A seller that chooses to offer product price information to a shopbot, makes that shopbot more attractive to buyers, as it includes one extra price quote compared to other shopbots that do not receive the seller's price information. Therefore, the added information increases the chances that a price sensitive shopper will find a better deal. Accordingly, sellers benefit from selling this price information to the shopbot (or through the shopbot, directly to the shopper), thereby generating substantial additional revenue from a previously unrecognized income stream.

1.3. The Shopbot's Problem.

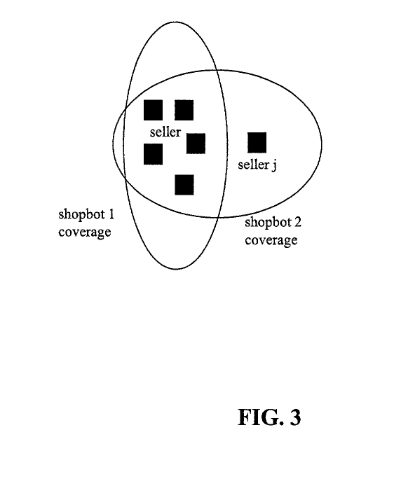

A problem faced by the shopbot is whether or not to accept an arrangement with the jth seller. For example, as shown in FIG. 3, one shopbot, S1, may not wish to help sellers charge for price information. As a result, the seller may contract with another shopbot, S2, that will do so, in which case, a prospective buyer would have to choose between the two shopbots. It is assumed that the buyer can only choose one shopbot, since if he wants to visit shopbot 1, and then after getting a minimum price go to shopbot 2 to see if there are other sellers in the market, the model becomes equivalent to the model studied in section 1.1.

A rational buyer knows that the expected cost, should he visit S1 is q given by

$$E ( {f}_{min}^{N - 1} ) ,$$

while the cost of visiting

$$S2 is E ( {f}_{min}^{N} ) .$$

If it is known to the buyer that the cost to get an additional price quote is

$$E ( {f}_{min}^{N - 1} ) - E ( {f}_{min}^{N} ) - ε ,$$

then the buyer will always visit S2. Thus, the first shopbot that makes an exclusive deal with one or more sellers will attract all traffic, leading the other shopbots to make similar deals.

2.0. Selling Price Information Is Counterintuitive.

Selling price information on an individual basis in accordance with the present invention is a new and counterintuitive idea, and hence novel and non-obvious. Proof that the present pricing scheme leads to a profitable business model is fairly subtle. It is counterintuitive that a business model that introduces cost and inconvenience to the shopper (the shopper has to explicitly buy the price information for a particular product) can be profitable, as opposed to convenient methods, such as the ones currently employed (free or subscription based).

Current practitioners either provide price information for free, or use the subscription method, wherein a shopper, for a flat fee, has full access to all price information available at a web site. Because charging for information about prices is counter-intuitive, no one in the e-commerce market has considered the possibility prior to the present invention, even though there are important benefits, both theoretically and practically. The prior art offers no scientific literature on this topic.

The present invention meets an unfulfilled demand in the world of electronic commerce. Sellers are known to block shopbot access from their websites. The most prominent case is probably the legal dispute between e-Bay and a number of auction aggregators that scan e-Bay's website to help their visitors compare auction prices. The present invention provides a solution to this dispute, as buyers could be charged to access e-Bay's price information through the auction aggregators. The fact, that this solution has not been implemented, further points to the counterintuitiveness of this invention.

3.0 Sellers Compete in Selling Price Information.

Given the finding of the present invention that it can be profitable for a seller to sell price information through a shopbot, and that it can withstand competition from other sellers or shopbots, it is reasonable to expect that more than one seller would want to sell price information. For the purposes of calculation, a model is presented, wherein all sellers charge money to reveal their price.

For example, it is assumed that there is a shopbot that displays price information of N different sellers that sell many different undifferentiated goods. As previously discussed, product prices p follow a random distribution f(p) with the equivalent cumulative distribution denoted by F(p), constant across time, which is exogenous to the model. Shopbot users know the distribution of the prices in the market, but do not know which seller is the cheapest for the particular product in which they are interested. Moreover, they have no preferences for particular sellers, and they are willing to buy from the one that offers the lowest price for the product.

3.1. The Shopper's Problem.

In the extreme case, where all sellers charge for price information, the prospective shopper would not be able to find any shopbot that provides price information for free. This would be true, unless the shopbot wishes to absorb the cost for the shopper, in which case the shopper's problem is trivial, since all price information is displayed for free (although as explained in section 3.3 below, it is noted that such a scenario might not always be feasible).

However, returning to the present model, in which it is assumed that the shopper would visit the shopbot, where prices across sellers can quickly be searched and compared instead of visiting each seller's individual web site, which is a much more time consuming task. The optimal consumer behavior has been explored in the economic literature, reviewed, e.g., by Rothschild, The Journal of Political Economy 81(6):1283-1308 (1973). The buyer would keep searching as long as the expected decrease in the minimum price for another search is less than what the buyer has to pay for it. If the buyer believes that all product prices follow the same distribution, the search would start from the prices that are least expensive to acquire. This assumes that if two price information prices are the same, the buyer would choose one at random. If the current minimum price is q, then the expected decrease in the minimum price from another search is a function of q and F as set forth in Equation 1.

Procedurally, the shopper would start by requesting price information on the products that is cheapest to acquire, and stop when the lowest price p requested by a seller to reveal price information is greater than the expected marginal product price decrease: p>g(q). The optimal sequential decision rule is for the shopper to continue searching if the lowest price observed up to that point is greater than R, where R is the solution to g(R)=p.

3.2. The Sellers Problem.

The seller's problem is presented as a game-theoretic analysis of the shopbot model, in which a Nash equilibrium is considered, assuming that sellers are rational (profit maximizers), and that shoppers are also rational (utility maximizers). A Nash equilibrium is a vector of prices at which sellers maximize their individual profits, shoppers maximize their individual utilities, and from which no agent has any incentive to deviate (Nash, Annals of Mathematics 54:286-295 (1951)). In fact, as will be shown, there can be no pure strategy Nash equilibrium when sellers compete in selling price information, rather, there exist multiple subgame perfect Nash equilibria.

In the situation in which two sellers each set price information at the same price p, and when a shopper has to choose between the two sellers, the shopper will presumably choose one price at random. Consequently, one of the sellers can offer a discount, ∈, to make sure that the shopper will always prefer his price information over that of his competitor. Naturally, ∈ can be chosen so that the decrease in price information revenue due to the lower price is smaller than the increase in revenue due to the higher probability of actually selling price information. Also, selling price information at zero cost is not within the considerations of the perfect Nash equilibrium, since a seller is always strictly better off charging a price above zero, rather than charging zero. This is true, even if everybody else is selling price information at zero.

Conversely, there can also be no equilibrium when sellers charge different prices for the price information. For the market to be in equilibrium, all sellers would have to be earning the same revenue.

When one considers two sellers S₁ and S₂ charging p₁ and p₂, with no other sellers at intermediate prices, it is obvious from the model that S₁, would be chosen with some probability α₁, and S₂ with α₂, wherein α₁>α₂. The equilibrium assumption requires that p₁α₁=p₂α₂. If S₁ sets price at p₂−∈, then the new α′₁, would still be greater than α′₂ and ∈ can be chosen arbitrarily small, so that α′₁ (p₂−∈)>α₂p₂. As a result, S₁ can always earn higher revenue by raising the price.

There are, however, multiple subgame perfect Nash equilibria possible in the infinitely repeated game in there are N sellers. Moreover, it can be assumed that when setting their own price information, the sellers do not know each other's product prices for the specific product for which the shopper is searching. (The situation wherein sellers do know each other's prices is considered below.)

The structure of the scenario and the payoffs for sellers are set forth as follows when (i) two sellers S₁ and S₂ compete in selling price information, (ii) at each stage they choose price p₁ and p₂, respectively, for their price information, and (iii) their payoffs have the following form: if p₁<p₂, then S₁ will receive a payoff of p₁ and S₂ a payoff of p₂ ∫ₚ₂^{∞}f(q)g(q)dq. The integral p₂∫ₚ₂^{∞}f(q)g(q)dq is simply the probability that after the shopper acquires S₁'s price, the expected product price decrease by also acquiring S₂'s price, is less than p₂. In other words, the integral summarizes the probability that S₂'s product price will be requested. For simplicity, it is assumed that the prices the sellers choose will always be less than c, which as previously defined is the cost for the shopper to directly visit a seller's website.

If p₁>p₂, the payoffs are symmetric. Moreover, if p₁=p₂=p, the payoff for both sellers is rₚ=(½)p+(½)p ∫ₚ₂ ^{∞}f(q)g(q)dq, because each seller has ½ probability that he will be chosen first.

Given the preceding assumptions and proofs, the existence of the multiple Nash equilibria can be proven, and its properties can be derived. If the model had a Nash equilibrium with payoffs (e₁, e₂) for the sellers, then any other feasible payoff (x₁, x₂), with xᵢ>e₁, by Friedman's theorem, would have a subgame-perfect Nash equilibrium of the infinitely repeated game that achieves x₁, x₂ as payoff (Gibbons, in Game Theory for Applied Economists. Princeton University Press, 1st edition (1992)). In the absence of a Nash equilibrium, e₁, e₂ can be substituted by the reservation payoffs—the largest payoff a seller can guarantee receiving, no matter what the other sellers do—(r₁, r₂), as shown by Fudenberg and Maskin (Econometrica 54, (1986)).

In the present invention, the reservation payoffs for both sellers are achieved when they price to maximize revenues, given that their price information will not be requested first. This is because the competitor can always undercut the price. The best a seller can hope for is to have the maximum possible revenue given that the competitor will undercut. It is assumed that the price that maximizes expected revenues, when the seller will not be the first to sell price information, is \overline{p}. As a result the reservation payoff for both sellers is r_{\overline{p}}=\overline{p}∫ₚ₂^{∞}f(q)g(q)dq, which is simply the price multiplied by the probability that the price information will be requested. Any payoff higher than this has a perfect Nash equilibrium that achieves it.

One strategy that leads to a Nash equilibrium is the following: given that both sellers price their price information at p, each seller would continue pricing at p, as long as the other seller has priced at p in all the previous periods. He would punish his competitor, at a cost, by pricing at zero from then on, if the competitor deviates. Thus, it is easy to see that the other seller would always be better off continuing pricing at p in every period, given his competitor's strategy. Of course, the price p must be such that both sellers' payoff is higher than rₚ, the reservation payoff.

One price, p*, that is guaranteed to have expected payoff at least as high as r_{\overline{p}}, if both sellers choose it, is the price that maximizes both sellers' revenues when they choose the same price for their price information. So, one Nash equilibrium is for sellers to follow the suggested strategy, pricing their price information at p*, with expected payoff for each seller r_{p*}=(1/2)p*+(1/2)p*∫_{p*}^{∞}f(q)g(q)dq. This is because each seller has a 1/2 probability that he will be chosen first. The extension to N sellers is trivial, under some mild conditions described by Fudenberg and Maskin.

The price p* that jointly maximizes price information revenue for N sellers is the price that maximizes κ(p),

$$π ( p ) = \frac{p}{N} ( 1 + {\sum }_{i = 2}^{N} Q ( p , i ) ) \qquad ( Equation 3 )$$

where Q(p,i) is the probability that a seller will be the ith to be queried given price p for his price information. The formula is derived as follows:

Sellers will jointly maximize the expected revenues from selling their price information. The expected price information revenue per -customer that uses a shopbot as a function of the price p the seller sells its price information is κ(p)=p[Prob(p is the lowest PIP)+Prob(p is the 2nd lowest PIP, but the buyer still pays for it)+ . . . +Prob(p is the Nth lowest PIP, but the buyer still pays for it)]. PIP represents Price Information Price.

When sellers collude, they choose the same price p for their price information. Thus, the probability that a seller is ith lowest, but the buyer still pays for the seller's price information is: 1/N·Prob(The marginal expected decrease in product price is greater than p).

If q is the current minimum product price discovered, then the marginal expected decrease in product price is: g(q)=∫_{-∞}^{q}(q−x)f(x)dx (see section 3.1), and the distribution of q is:

$${f}_{min}^{i - 1} ( q ) = ( i - 1 ) ( 1 - {F ( q )}^{i - 2} f ( q ) ( see section 1.2 ) .$$

Accordingly, for a given current, minimum, product price q, the probability that the marginal expected decrease in product price is greater than p is:

Q(p,i)=∫ₚ^{∞}((−1)(1−F(q)ⁱ⁻²f(q)∫_{-∞}^{q}F(x)dx)dq, for i≧2.

The expected price information revenue per customer is thus:

$$κ ( p ) = \frac{p}{N} ( 1 + {\sum }_{i = 2}^{N} Q ( p , i ) ) ,$$

assuming that p is always less than c, the cost to the shopper of visiting a seller's website directly.

It follows, therefore, that the only price for which a Nash equilibrium can be shown to exist is p*, since it is the only price that achieves an expected payoff at least as high as r_{\overline{p}}, when both sellers choose it. Furthermore, even if more Nash equilibria exist, the p* equilibrium is arguably the most probable, since all sellers know it, and it maximizes their average revenue from selling price information to shoppers.

The above model is actually a somewhat simplified version of reality. In fact, the Nash equilibrium of the infinitely repeated game might present the seller who has the lowest price product with a dilemma, since it is not guaranteed that the buyer will actually want to know the seller's price. Equation 4 above describes the seller's revenues on price information only, but it does not include product sales revenues. To understand this situation, one could assume that although a seller has the lowest price for a certain good, the seller might end up not selling the product if the buyer does not request seller's price. The buyer would on average request only a fraction, α, of the N product prices, in which 0≦α≧1, which depends on p and the distribution of product prices f(x). [α can be calculated by using the model developed by Stigler (The Journal of Political Economy 69(6):213-225 (1961)), inspiring future work on the economics of information. If gᵢ is the expected gain from searching for the price of i+1, then the seller would search on average k times, where k is such that gₖ≧p>gₖ₊₁, given price p for price information. In other words, α is simply k/N.]

Under these conditions, the seller who has the lowest price for a given product, and who would have captured all shopbot users had he provided price information for free, will now make only a fraction, α, of sales. Product prices and profit margins are exogenous to the model set forth in the present invention, but it should be clear that the lowest product price seller might end up lowering total revenue (product sales plus price information sales) if α is low enough. In addition, the seller would now have to reoptimize product price to account for the fact that only a fraction of the previously estimated shopbot sales are made. Even if this optimization would lead to higher overall profits, it might cause the seller to choose a price that is no longer the lowest in the market. This would simply propagate the seller's problem to the new lowest priced seller. Therefore, when more than one seller competes in selling price information, the only Nash equilibrium that is guaranteed to exist in strict terms might make the lowest product price seller worst off.

One solution to this seller's problem would be for sellers to price their price information low enough so that a rational shopper would always request it, even though the second lowest price in the market has been discovered. If the sellers know that the second lowest price in the market is q₂, then by charging ∫_{-∞}^{q2}F(x)dx−∈ for price information, the seller can be sure that they buyer will always eventually discover the lowest price. This pricing scheme can also be used when sellers have information on the competitor's product prices. In this case, all sellers would know that the lowest priced seller will try to guard product sales by making sure his price information price is always requested, and that such a seller will want to set his price to ∫_{-∞}^{q2}F(x)dx−∈.

Thus, a feasible, good strategy would be for all other sellers to match the price of the lowest seller. If those sellers try to undercut the price of the cheapest seller, then the buyer would know that they have done so. As a result, the reasonable shopper would know who was the original seller with the lowest price, as compared with the other product sellers, simply because the other sellers have undercut the original lowest price information. The buyer would not need to request any prices, and he could simply visit the cheapest seller's web site directly. Consequently, the other sellers would lose revenue if they attempt to undercut this price. Rather, there is an incentive to match the lowest price seller's price.

If all sellers charge the same low price, the buyer would have to request some or all of the prices to identify the cheapest seller. Other buyers can also follow a randomized strategy, but this would not provide any way to identify the cheapest seller of the product. Of course, this represents just one pricing strategy that works, without causing the cheapest seller to lose actual product sales.

Nevertheless, a seller is always better off, charging the low price described herein, rather than providing price information for free. Thus, according to the model set forth in the present invention, no seller should reveal price information for free to a shopbot.

3.3.The Shopbot's Problem.

The shopbot that wishes to attract buyers might want to absorb part or all of a buyer's costs in searching for the lowest price. A popular shopbot model is free for users, and makes revenues by displaying an advertising banner. A shopbot that earns a fixed revenue per customer, and that wishes to continue providing free price information, would have to share part of that revenue with sellers who demand money for their price information.

It is clear from the preceding section that the expected cost per customer rises as price dispersion increases, i.e., as sellers take advantage of the higher shopper uncertainty about prices. This means that the shopbot that covers a market with smaller price dispersions would have better chances in managing to absorb the customers costs in searching for the best price. Shopbots in markets with a higher price dispersion might find it difficult to cover for the shopper's costs by allocating part of the fixed revenue simply by selling advertising. However, even shopbots operating in markets with small price dispersions can have problems absorbing seller demands. Shopbots could benefit from the present invention, and employ the methods claimed to satisfy the seller's demands for selling price information to buyers.

In conclusion, price information is valuable to shoppers who search for the best deal on the internet, because considerable price dispersion exists. This fact will not go away when shopbots become even more popular, because different shoppers have different values for the “bundle of goods” represented by, for example, a simple product like a book (one gets the book, fulfillment speed, shopping convenience, trust of store, etc.) Shopbots that acquire and compare prices offer a valuable service to price sensitive shoppers. The value of price information in e-commerce has been largely neglected by researchers, but this value cannot be overlooked and it could influence the form of some internet markets. Pricebots are a competing method that does not mix well with this invention, and they have serious drawbacks that are overcome by the invention. In fact, the invention helps the sellers acquire the value that their price information has, without sacrificing the buyer's wish to find and buy the cheapest product

Each and every patent, patent application and publication that is cited in the foregoing specification is herein incorporated by reference in its entirety.

While the foregoing specification has been described with regard to certain preferred embodiments, and many details have been set forth for the purpose of illustration, it will be apparent to those skilled in the art that the invention may be subject to various modifications and additional embodiments, and that certain of the details described herein can be varied considerably without departing from the spirit and scope of the invention. Such modifications, equivalent variations and additional embodiments are also intended to fall within the scope of the appended claims.

What is claimed is:

1. A method for responding to a shopper's inquiry seeking price information on a product in a competitive marketplace, comprising:
receiving the shopper's inquiry for price information on a product;
searching for price information of advertised products matching the product for which the price is sought;
assembling identified price information into a response to the inquiry, wherein the price of at least one product is withheld from the response;
forwarding the assembled response to the shopper along with a cost for obtaining the previously withheld price information;
receiving the shopper's agreement to buy the previously withheld price information; and
forwarding to the shopper the previously withheld price information in exchange for the agreed upon payment of the cost for the price information.

2. The method of claim 1, wherein the search for price information comprises searching at least one database.

3. The method of claim 1, wherein the search for price information comprises electronically searching on a global computer network.

4. The method of claim 1, wherein forwarding of price information is provided to the seller by a shopbot.

5. The method of claim 1, further comprising providing information, including product price, by a seller of the product.

6. The method of claim 5, wherein product price information is purchased from a seller of the product.

7. The method of claim 6, wherein a shopbot purchases the price information from the seller.

8. The method of claim 1, wherein receiving the shopper's agreement to pay the cost for obtaining the previously withheld price information comprises shopper applied methods recognizable by an electronic device, selected from the group consisting of clicking or pressing a button on a computer or communications device, following a link displyed on a web page on a global computer network, touching a designated point on a screen or display panel attached to a computer or communications device, and speaking a selection into an audio receiver attached to a computer or communications device.

9. The method of claim 1, further comprising the paying by the buyer of the agreed upon cost for price information, wherein payment comprises any agreed upon medium, goods or services, and wherein the medium is not limited to money.

10. The method of claim 1, further comprising agreeing to pay a predetermined amount to obtain the lowest price from among the assembled prices.

11. The method of claim 1, further comprising agreeing to view or interact with a banner advertisment in exchange for the price information.

12. A database on a computer readable medium for facilitating a response to a shopper's inquiry seeking price information on a product in a competitive marketplace, wherein the price information is provided to the shopper for a fee, comprising:
a first data object;
a second data object;
a third data object;
a fourth object;
a fifth object;
whereby any of the data objects are instantiated in order to populate the database.

13. The database according to claim 12, whereby the first object further comprises a field for entering an inquiry asking for price information of a product.

14. The database according to claim 13, whereby the second object further comprises a field for searching for price information of advertised products.

15. The database according to claim 14, whereby the second object further comprises a data source for the third object.

16. The database according to claim 15, whereby the third object further comprises a field for assembling product price information into a response, wherein the price of at least one product is withheld from the response, and wherein a cost is provided for which the withheld price will be provided.

17. The database according to claim 16, whereby the fourth object further comprises a field for receiving an agreement to buy the previously withheld price information.

18. The database according to claim 17, whereby the fifth object further comprises a field for forwarding the previously withheld price information in exchange for the agreed upon payment of the cost for the price information.

19. A system for accessing a database for facilitating a response to a shopper's inquiry seeking price information on a product in a competitive marketplace, wherein the price information is provided to the shopper for a fee, comprising
means for receiving the shopper's inquiry for price information on a product;
means for searching for price information of advertised products matching the product for which the price is sought;
means for assembling identified price information into a response to the inquiry, wherein the price of at least one product is withheld from the response;
means for forwarding the assembled response to the shopper along with a cost for obtaining the previously withheld price information;
means for receiving the shopper's agreement to buy the previously withheld price information; and
means for forwarding to the shopper the previously withheld price information in exchange for the agreed upon payment of the cost for the price information.

20. The system of claim 19, further comprising a network based apparatus.

21. The system of claim 19, wherein the system, at least in part, comprises a first apparatus in a client-server relationship with a second apparatus.
